(19) United States
(12) Patent Application Publication
(10) Pub. No.: US 2016/0380582 A1
(43) Pub. Date: Dec. 29, 2016

(54) PHOTOVOLTAIC POWER GENERATION APPARATUS

(71) Applicant: KD POWER CO., LTD., Chuncheon-si (KR)

(72) Inventors: Gi Ju PARK, Seoul (KR); Yun Seo GU, Seoul (KR)

(21) Appl. No.: 14/985,346

(22) Filed: Dec. 30, 2015

(30) Foreign Application Priority Data
Jun. 24, 2015 (KR) 10-2015-0089910

(51) Int. Cl. H02S 40/10; H02S 30/10

(52) U.S. Cl. CPC H02S 40/10; H02S 30/10

(57) ABSTRACT

A photovoltaic power generation apparatus includes a support frame, on which solar cell modules are mounted such that neighboring solar cell modules are spaced apart from each other by a predetermined gap set in a lateral direction. A pair of guide rails is mounted on the support frame in a parallel manner at opposite sides of the solar cell modules. A cleaning unit reciprocates on the guide rails in a horizontal direction to clean upper surfaces of the solar cell modules by rotation. Interference frames are mounted on the support frame in the predetermined gaps or at opposite ends of the solar cell modules. The interference frames are arranged at a height at least equal to or higher than the upper surfaces of the solar cell modules such that the cleaning unit contacts the interference frames while rotating or reciprocating.

This application claims the benefit of Korean Patent Application No. 10-2015-0089910, filed on Jun. 24, 2015, which is hereby incorporated by reference as if fully set forth herein.

### BACKGROUND OF THE INVENTION

Field of the Invention

The present invention relates to a photovoltaic power generation apparatus, and more particularly to a photovoltaic power generation apparatus configured such that foreign matter, such as dust, is removed from the surfaces of solar cell modules, thereby improving the efficiency of photovoltaic power generation.

Discussion of the Related Art

In recent years, the exhaustion of fossil fuels, such as petroleum and coal, has been predicted, with the result that interest in alternative energy resources as substitutes for fossil fuels has risen. Among such alternative energy resources is photovoltaic energy, which is in the spotlight.

A power generation apparatus for producing electricity using photovoltaic energy is classified as a solar heat power generation apparatus for driving a heat engine using solar heat to generate electricity or a photovoltaic power generation apparatus for generating electricity from solar cells using solar light.

The minimum unit in a photovoltaic power generation apparatus is an individual solar cell. The voltage that is required in order to be actually useful ranges from several volts to several tens or hundreds of volts, whereas the voltage obtained from each solar cell is about 0.5 V, which is very low. For this reason, a plurality of solar cells is connected in series or in parallel to each other based on the capacity required.

In a case in which solar cells are used outdoors, the solar cells may be subjected to various severe environmental conditions. In order to protect the solar cells from such severe conditions, the solar cells are combined to constitute a solar cell module.

In general, the solar cell module is mounted at an optimal angle in consideration of the trajectory of the sun. To this end, the solar cell module is mounted in a state in which the solar cell is inclined to receive the maximum amount of light from the sun. In addition, the solar cell module is mounted in a sunny place.

If foreign matter, such as dust, accumulates on the upper surface of the solar cell module, however, the efficiency of power generation is sharply reduced. Furthermore, if the amount of electric power generated by some of the cells in a solar cell module is reduced, the total amount of electric power generated by the solar cell module is also reduced.

### SUMMARY OF THE INVENTION

Accordingly, the present invention is directed to a photovoltaic power generation apparatus that substantially obviates one or more problems due to limitations and disadvantages of the related art.

An object of the present invention is to provide a photovoltaic power generation apparatus that includes a cleaning unit capable of cleaning the upper surfaces of solar cell modules while periodically reciprocating, thereby maximally improving the efficiency of photovoltaic power generation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a photovoltaic power generation apparatus includes a support frame, on which a plurality of solar cell modules is mounted such that neighboring ones of the solar cell modules are spaced apart from each other by a predetermined gap, set in a lateral direction, a pair of guide rails mounted on the support frame such that the guide rails are arranged parallel to each other at opposite sides of the solar cell modules, a cleaning unit configured to reciprocate on the guide rails in a horizontal direction for cleaning the upper surfaces of the solar cell modules by rotating, a pair of driving units provided at opposite ends of the cleaning unit for providing driving force necessary for the cleaning unit to reciprocate on the guide rails, a power unit connected to the driving units such that the power unit is rotatable, the power unit being driven along the guide rails by the motion of chains, and interference frames mounted on the support frame such that the interference frames are provided in the predetermined gaps or at opposite ends of the solar cell modules, the interference frames being arranged at a height at least equal to or higher than the upper surfaces of the solar cell modules such that the cleaning unit contacts the interference frames while rotating or reciprocating.

Each of the interference frames may be provided at the upper surface thereof, which the cleaning unit contacts while rotating, with a plurality of slits.

The slits may be formed in a direction different from a direction in which ends of brushes provided at the cleaning unit advance.

The guide rails may extend along the support frame in a longitudinal direction, and a guide groove may be formed along the upper surface or the side surface of each of the guide rails in the longitudinal direction.

The driving unit may include a roller unit configured to contact the guide rails such that the roller unit rolls on the guide rails, the roller unit including a first roller configured to rotate while contacting the upper surface of each of the guide rails and a second roller configured to rotate while contacting the side surface of each of the guide rails.

The first roller or the second roller may include a support piece protruding from the outer circumferential surface thereof so as to be partially inserted into the guide groove.

The photovoltaic power generation apparatus may further include a connection frame disposed on the cleaning unit for interconnecting the driving units.

The photovoltaic power generation apparatus may further include a first sensor unit provided on the support frame for setting an operation area of the power unit and a second sensor unit disposed adjacent to the first sensor unit for sensing the operation area of the power unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view showing a photovoltaic power generation apparatus according to the present invention;

FIG. 2 is a plan view showing the photovoltaic power generation apparatus shown in FIG. 1;

FIG. 3 is a side view showing the photovoltaic power generation apparatus shown in FIG. 1;

FIG. 4 is a partially enlarged view showing a cleaning unit of the photovoltaic power generation apparatus shown in FIG. 1;

FIG. 5 is a partially enlarged view showing the upper surface of the photovoltaic power generation apparatus shown in FIG. 1;

FIG. 6 is a partially enlarged front sectional view showing a driving unit of the photovoltaic power generation apparatus shown in FIG. 4;

FIG. 7 is a partially enlarged plan view showing the driving unit of the photovoltaic power generation apparatus shown in FIG. 4; and

FIG. 8 is a partially enlarged side view showing the driving unit of the photovoltaic power generation apparatus shown in FIG. 4.

### DETAILED DESCRIPTION OF THE INVENTION

Now, embodiments will be described with reference to the annexed drawings to enable those skilled in the art to easily implement the embodiments. In the drawings, the same or similar elements are denoted by the same reference numerals even when they are depicted in different drawings. In addition, in the following description of the embodiments, a detailed description of known functions and configurations incorporated herein will be omitted when it may make the subject matter of the embodiments rather unclear. Some features of the drawings are enlarged, reduced, or simplified for convenience of description, and the drawings and components thereof are not necessarily shown at an appropriate ratio, which will be easily understood by those skilled in the art.

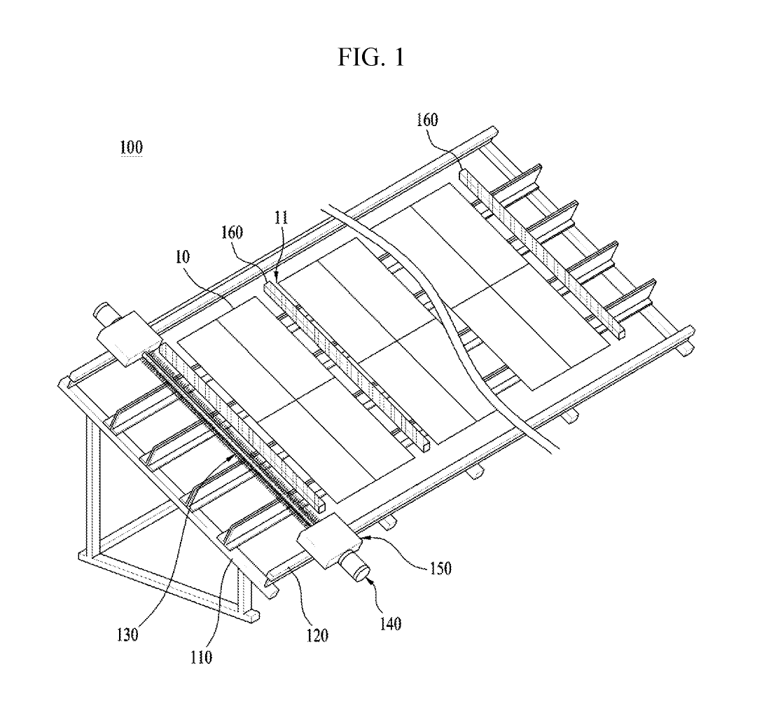

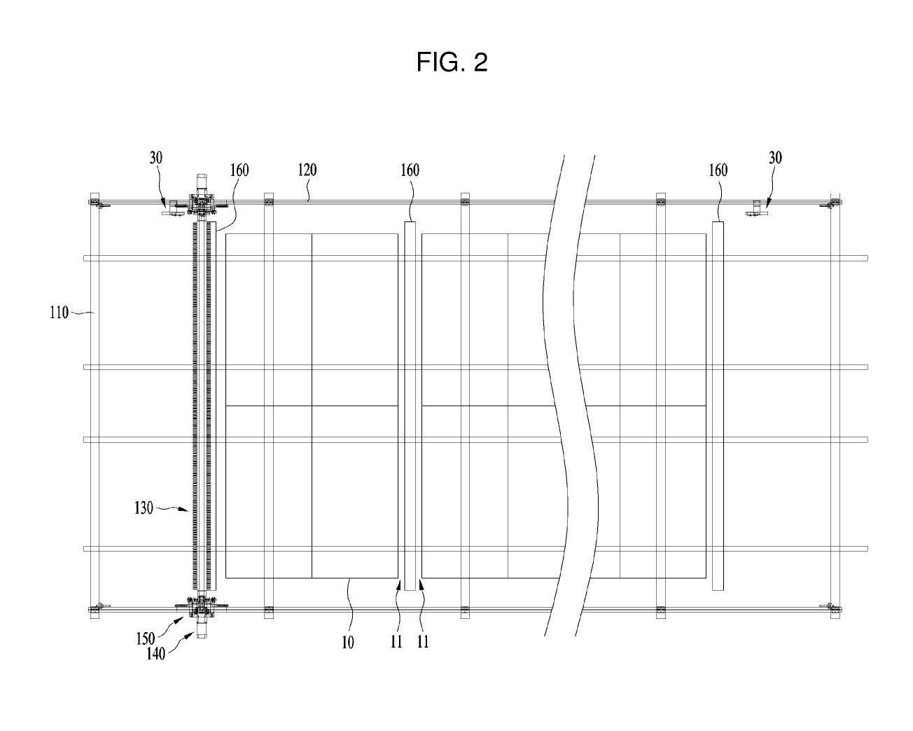

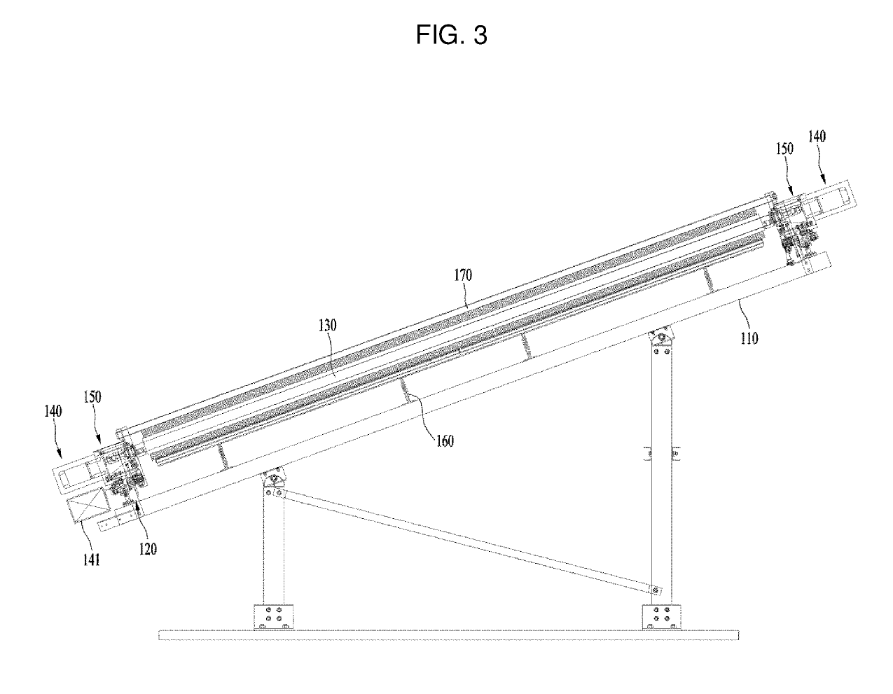

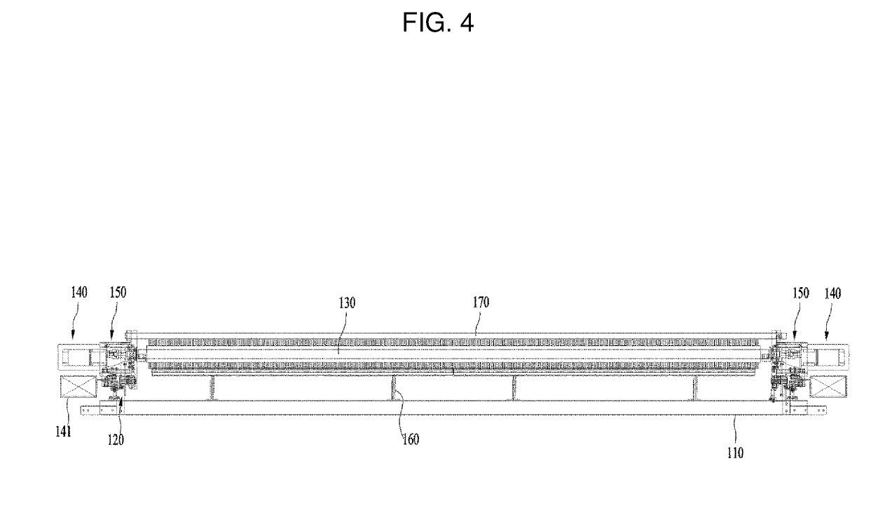

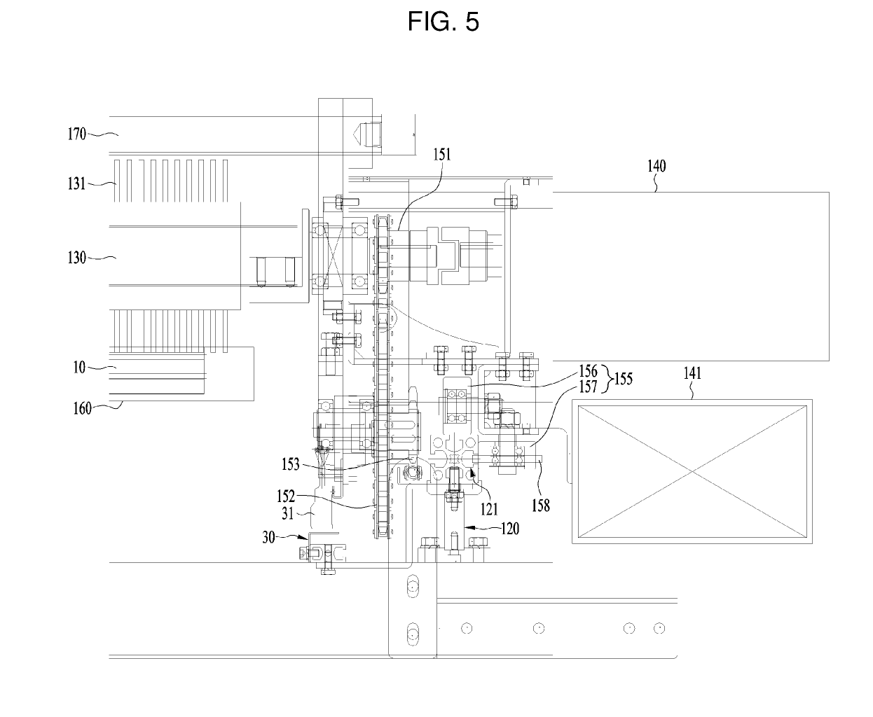

FIG. 1 is a perspective view showing a photovoltaic power generation apparatus according to the present invention, FIG. 2 is a plan view showing the photovoltaic power generation apparatus shown in FIG. 1, FIG. 3 is a side view showing the photovoltaic power generation apparatus shown in FIG. 1, FIG. 4 is a partially enlarged view showing a cleaning unit of the photovoltaic power generation apparatus shown in FIG. 1, and FIG. 5 is a partially enlarged view showing the upper surface of the photovoltaic power generation apparatus shown in FIG. 1.

Referring to FIGS. 1 to 5, a photovoltaic power generation apparatus 100 according to the present invention includes a support frame 110, on which a plurality of solar cell modules 10 are mounted such that neighboring ones of the solar cell modules 10 are spaced apart from each other by a predetermined gap 11 set in a lateral direction, a pair of guide rails 120 mounted on the support frame 110 such that the guide rails 120 are arranged parallel to each other at opposite sides of the solar cell modules 10, a cleaning unit 130 configured to reciprocate on the guide rails 120 in a horizontal direction for cleaning the upper surfaces of the solar cell modules 10 by rotating, a pair of driving units 140 for providing driving force necessary for the cleaning unit 130 to reciprocate on the guide rails 120, and interference frames 160 mounted on the support frame 110 such that the interference frames 160 are provided in the predetermined gaps 11 or at opposite ends of the solar cell modules 10, the interference frames 160 being arranged at a height at least equal to or higher than the upper surfaces of the solar cell modules 10 such that the cleaning unit 130 contacts the interference frames 160 while rotating or reciprocating.

The photovoltaic power generation apparatus 100 further includes a power unit 150 driven along the guide rails 120 by the motion of chains.

The cleaning unit 130, which is disposed on the upper surfaces of the solar cell modules 10, includes a plurality of brushes 131. The cleaning unit 130 reciprocates on the upper surfaces of the solar cell modules 10 in the horizontal direction to clean the upper surfaces of the solar cell modules 10.

In order to improve the cooling performance of the solar cell modules 10 on the support frame 110, the solar cell modules 10 are coupled to the support frame 110 by means of a plurality of brackets such that the solar cell modules 10 are spaced apart from the support frame 110.

In addition, the solar cell modules 10 are easily mounted to the support frame 110 by means of the brackets such that neighboring ones of the solar cell modules 10 are spaced apart from each other by the predetermined gap 11.

Since neighboring ones of the solar cell modules 10 are spaced apart from each other by the predetermined gap 11, the cleaning unit 130 discharges foreign matter from the upper surfaces of the solar cell modules 10 to the outside while moving.

The interference frames 160 are disposed between neighboring ones of the solar cell modules 10 such that the cleaning unit 130 contacts the interference frames 160 while rotating. Consequently, the interference frames 160 function to more effectively sweep foreign matter off the cleaning unit 130.

To this end, a plurality of slits 161 is formed at the upper surface of each of the interference frames 160. The slits 161 increase the area of each of the interference frames 160 that the cleaning unit 130 contacts while rotating. In addition, the slits 161 are formed in a direction different from a direction in which the brushes 131 of the cleaning unit 130 advance during the rotation of the cleaning unit 130 in order to increase frictional force between the cleaning unit 130 and each of the interference frames 160.

Consequently, the cleaning unit 130 discharges foreign matter from one of the solar cell modules 10 to the outside through the predetermined gap 11 before the movement of the cleaning unit 130 from one of the solar cell modules 10 to a neighboring one of the solar cell modules 10. At the same time, the cleaning unit 130 frictionally contacts a corresponding one of the interference frames 160. As a result, residual foreign matter attached to the cleaning unit 130 is discharged to the outside through the predetermined gap 11. Consequently, it is possible for the cleaning unit 130 to rotate in a clean state when the cleaning unit 130 starts to move on a neighboring one of the solar cell modules 10.

The guide rails 120 extend along the support frame 110 in a longitudinal direction. The guide rails 120 function to guide the reciprocation of the cleaning unit 130, the driving units 140, or the power unit 150. One of the guide rails 120 is provided along the upper edges of the solar cell modules 10 in the longitudinal direction while being adjacent to the upper edges of the solar cell modules 10, and the other of the guide rails 120 is provided along the lower edges of the solar cell modules 10 in the longitudinal direction while being adjacent to the lower edges of the solar cell modules 10. In addition, a guide groove 121 is formed along the upper surface or the side surface of each of the guide rails 120 in the longitudinal direction.

One of the driving units 140 is provided at one end of the cleaning unit 130, and the other of the driving units 140 is provided at the other end of the cleaning unit 130. The driving units 140 may alternately provide driving force to the cleaning unit 130, or may simultaneously provide driving force to the cleaning unit 130.

The photovoltaic power generation apparatus 100 further includes a connection frame 170 disposed on the cleaning unit 130 for interconnecting the driving units 140. The connection frame 170 interconnects the driving units 140 in a state in which the cleaning unit 130 is disposed between the driving units 140 in order to improve the rigidity of the driving units 140. In the connection frame 170 is disposed a power cable, which supplies electric power from one of the driving units 140 to the other of the driving units 140.

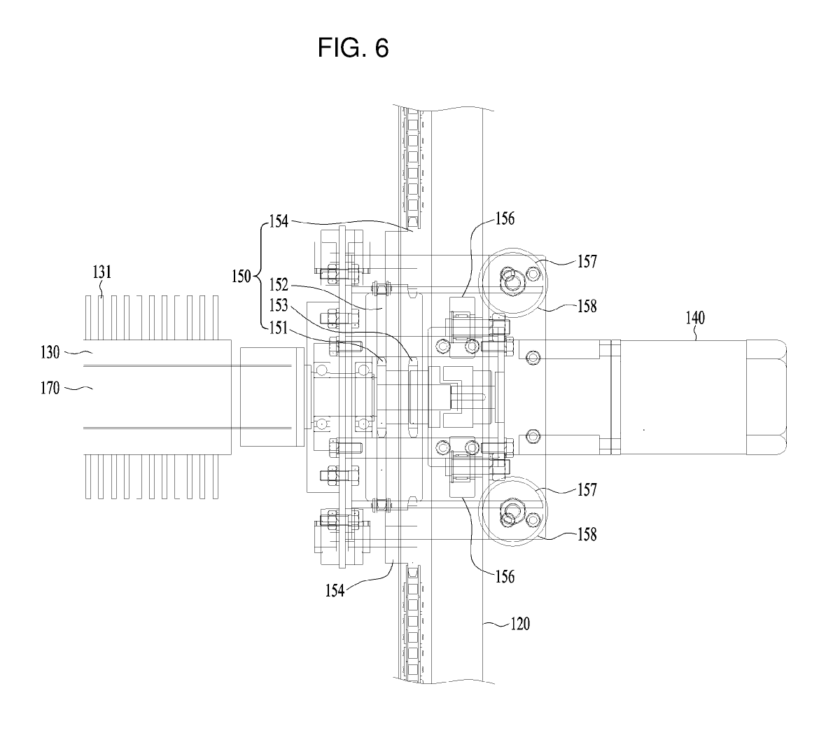

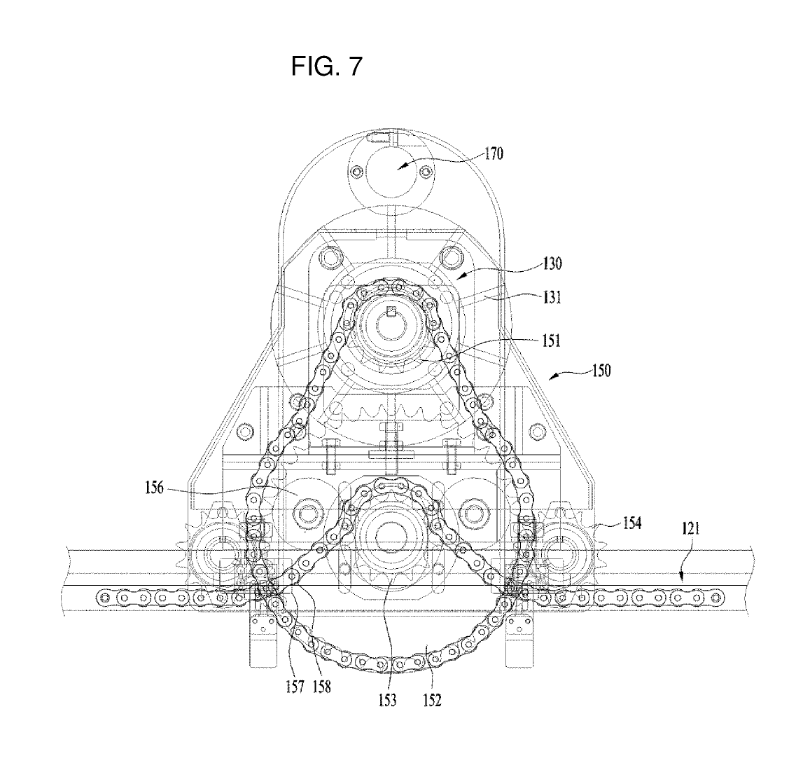

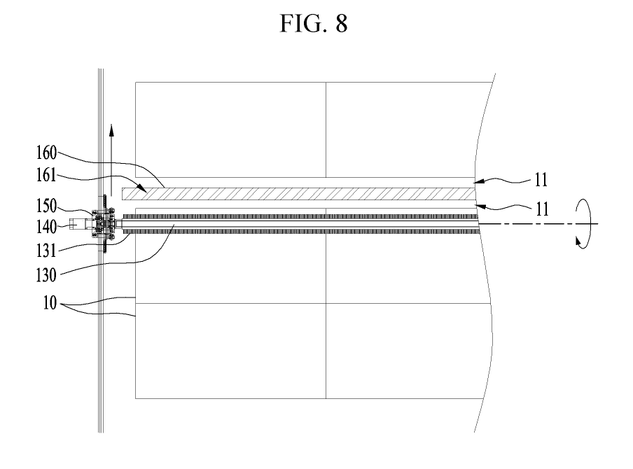

FIG. 6 is a partially enlarged front sectional view showing one of the driving units 140 of the photovoltaic power generation apparatus 100 shown in FIG. 4, FIG. 7 is a partially enlarged plan view showing the driving unit 140 of the photovoltaic power generation apparatus 100 shown in FIG. 4, and FIG. 8 is a partially enlarged side view showing the driving unit 140 of the photovoltaic power generation apparatus 100 shown in FIG. 4.

Referring to FIGS. 6 to 8, the operation of the driving unit 140 and the power unit 150 is achieved by driving a plurality of chains.

The power unit 150 includes a first rotary body 151, a second rotary body 152, a third rotary body 153, a fourth rotary body 154, and a roller unit 155.

One end of the first rotary body 151 is directly connected to the driving unit 140 such that driving force from the driving unit 140 is transmitted to the first rotary body 151.

The cleaning unit 130 is connected to the other end of the first rotary body 151. When electric power is supplied to the driving unit 140, the first rotary body 151 and the cleaning unit 130 are rotated simultaneously.

The third rotary body 153 is disposed under the first rotary body 151. The third rotary body 153 has a larger diameter than the first rotary body 151 such that a gear ratio of the third rotary body 153 to the first rotary body 151 is high. The second rotary body 152 is provided at the center of the third rotary body 153 such that the second rotary body 152 is integrally formed with the third rotary body 153. When the third rotary body 153 is rotated, therefore, the second rotary body 152 is also rotated.

Rotational force is transmitted between the first rotary body 151 and the third rotary body 153 by the motion of chains. Since the gear ratio of the third rotary body 153 to the first rotary body 151 is large, the third rotary body 153 has a lower rotational speed and provides a larger force than the first rotary body 151.

The second rotary body 152 is interlocked with the fourth rotary body 154 in order to achieve the motion of chains. The second rotary body 152 provides driving force necessary to reciprocate the power unit 150 along the guide rails 120.

The chain is engaged to the second rotary body 152 and the fourth rotary body 154 at different heights. Consequently, the second rotary body 152 and the fourth rotary body 154 rotate in opposite directions.

Since the chain is engaged to the second rotary body 152 and the fourth rotary body 154 at different heights, the fourth rotary body 154 also functions to maintain the tension of the chain with respect to the second rotary body 152.

The roller unit 155 functions to support the power unit 150 on a corresponding one of the guide rails 120 in vertical and horizontal directions and to reduce frictional force.

The roller unit 155 includes a first roller 156 configured to rotate while contacting the upper surface of the guide rail 120 and a second roller 157 configured to rotate while contacting the side surface of the guide rail 120.

The first roller 156 and/or the second roller 157 includes a support piece 158 protruding from the outer circumferential surface thereof so as to be inserted into the guide groove 121 formed at the guide rail 120. The support piece 158 is formed at the first roller 156 and/or the second roller 157 to prevent the cleaning unit 130, the driving unit 140, and the power unit 150 from being separated from the guide rail 120.

Although not shown in the figures, the roller unit 155 may be selectively disposed at the lower surface of the guide rail 120 as well as the upper surface and the side surface of the guide rail 120.

A controller 141 is provided to control the operation of the driving unit 140 or the power unit 150, and a first sensor unit 30 is provided on the support frame 110 to restrict the distance that the power unit 150 rectilinearly reciprocates along the guide rail 120. In addition, a second sensor unit 31, disposed adjacent to first sensor unit 30 for sensing a start point or an end point of a region within which the power unit 150 moves, is provided under the power unit 150. Consequently, the controller 141 controls the power unit 150 to reciprocate within a predetermined region on the guide rail 120 through the first sensor unit 30 and the second sensor unit 31.

Hereinafter, the operation and effects of the photovoltaic power generation apparatus according to the present invention will be described in detail with reference to the accompanying drawings.

First, when electric power is supplied from the driving unit 140, the first rotary body 151 is rotated.

The cleaning unit 130 is rotated simultaneously when the first rotary body 151 is rotated. As a result, foreign matter, such as dust, is removed from the upper surfaces of the solar cell modules 10.

The third rotary body 153, which is connected to the first rotary body 151 via the chain, is rotated, and the second rotary body 152, which is integrally formed with the third rotary body 153, is rotated.

When the second rotary body 152 is rotated, the power unit 150 is moved between the second rotary body 152 and the fourth rotary body 154 by the motion of chains.

As a result, the rotation of the cleaning unit 130 and the movement of the power unit 150 are performed simultaneously so as to clean the upper surfaces of the solar cell modules 10.

At this time, the cleaning unit 130 is rotated in a direction in which the cleaning unit 130 pushes the upper surfaces of the solar cell modules 10 such that frictional force is increased in a direction in which the power unit 150 moves. In other words, referring to FIG. 8, when the power unit 150 is moved to the right, the cleaning unit 130 is rotated on the upper surfaces of the solar cell modules 10 in a counterclockwise direction. On the other hand, when the power unit 150 is moved to the left, the cleaning unit 130 is rotated on the upper surfaces of the solar cell modules 10 in a clockwise direction.

Consequently, the power unit 150 pushes foreign matter, such as dust, removed from the upper surfaces of the solar cell modules 10 by the cleaning unit 130, to the opposite edges of the solar cell modules 10 while moving.

At this time, the foreign matter removed from the upper surface of one of the solar cell modules 10 is discharged to the outside through the predetermined gap 11, and the cleaning unit 130 contacts a corresponding one of the interference frames 160. As a result, residual foreign matter is removed from the cleaning unit 130. Consequently, the cleaning unit 130 cleans the upper surface of a neighboring one of the solar cell modules 10 in a state in which the cleaning unit 130 is clean.

Two interference frames 160 may be disposed at the opposite ends of the solar cell modules 10 at which the cleaning starts and ends. In addition, at least one interference frame 160 may be disposed between the solar cell modules 10.

The photovoltaic power generation apparatus 100 may selectively set a cleaning time or cleaning cycle through the controller 141.

In the photovoltaic power generation apparatus 100, therefore, the upper surfaces of the solar cell modules 10 continuously remain clean, thereby optimizing the efficiency of power generation.

As is apparent from the above description, the present invention has the following effects.

First, it is possible to prevent foreign matter from accumulating on the upper surfaces of the solar cell modules such that the upper surfaces of the solar cell modules continuously remain clean, thereby maximally improving efficiency in power generation.

Second, it is possible to adjust the cleaning time or cleaning cycle of the cleaning unit, thereby improving the convenience of use.

Third, it is possible to provide high cleaning performance, even based on a simple structure.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A photovoltaic power generation apparatus comprising:
a support frame, on which a plurality of solar cell modules is mounted such that neighboring ones of the solar cell modules are spaced apart from each other by a predetermined gap, set in a lateral direction;
a pair of guide rails mounted on the support frame such that the guide rails are arranged parallel to each other at opposite sides of the solar cell modules;
a cleaning unit configured to reciprocate on the guide rails in a horizontal direction for cleaning upper surfaces of the solar cell modules by rotation;
a pair of driving units provided at opposite ends of the cleaning unit for providing driving force necessary for the cleaning unit to reciprocate on the guide rails;
a power unit connected to the driving units such that the power unit is rotatable, the power unit being driven along the guide rails by motion of chains; and
interference frames mounted on the support frame such that the interference frames are provided in the predetermined gaps or at opposite ends of the solar cell modules, the interference frames being arranged at a height at least equal to or higher than the upper surfaces of the solar cell modules such that the cleaning unit contacts the interference frames while rotating or reciprocating.

2. The photovoltaic power generation apparatus according to claim 1, wherein each of the interference frames is provided at an upper surface thereof, which the cleaning unit contacts while rotating, with a plurality of slits.

3. The photovoltaic power generation apparatus according to claim 2, wherein the slits are formed in a direction different from a direction in which ends of brushes provided at the cleaning unit advance.

4. The photovoltaic power generation apparatus according to claim 1, wherein the guide rails extend along the support frame in a longitudinal direction, and a guide groove is formed along an upper surface or a side surface of each of the guide rails in the longitudinal direction.

5. The photovoltaic power generation apparatus according to claim 4, wherein the driving unit comprises a roller unit configured to contact the guide rails such that the roller unit rolls on the guide rails, the roller unit comprising:
a first roller configured to rotate while contacting the upper surface of each of the guide rails; and
a second roller configured to rotate while contacting the side surface of each of the guide rails.

6. The photovoltaic power generation apparatus according to claim 5, wherein the first roller or the second roller comprises a support piece protruding from an outer circumferential surface thereof so as to be partially inserted into the guide groove.

7. The photovoltaic power generation apparatus according to claim 1, further comprising a connection frame disposed on the cleaning unit for interconnecting the driving units.

8. The photovoltaic power generation apparatus according to claim 1, further comprising:
a first sensor unit provided on the support frame for setting an operation area of the power unit; and
a second sensor unit disposed adjacent to the first sensor unit for sensing the operation area of the power unit.
